(19) United States
(12) Patent Application Publication
(10) Pub. No.: US 2010/0033576 A1
(43) Pub. Date: Feb. 11, 2010

(54) DATA DELIVERY DEVICE

(75) Inventors: Takeshi Shibata, Yokohama (JP); Kunihiko Toumura, Hachioji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/534,474

(22) Filed: Aug. 3, 2009

(30) Foreign Application Priority Data
Aug. 7, 2008 (JP) 2008-203831

(51) Int. Cl. H04N 7/18

(52) U.S. Cl. 348/159; 348/E07.085

(57) ABSTRACT

A data delivery device that switches picture data to be delivered so that pictures different in quality can be efficiently grasped without missing information of a high importance level is provided. The data delivery device receives picture data from multiple cameras through a network using a picture reception program. It determines whether or not to display each image frame of the picture data by accumulating the frequency of viewpoint switching or the importance level information of an image from each viewpoint by a picture selection program. In addition, it delivers a selected image frame through an interface by a picture transmission program. The display time for each frame is varied according to the importance level information of the image to enhance the viewability of an important frame.

### CLAIM OF PRIORITY

The present application claims priority from Japanese Patent Application JP2008-203831 filed on Aug. 7, 2008, the content of which is hereby incorporated by reference into this application.

### BACKGROUND OF THE INVENTION

1. Field of the Invention

The present invention relates to data delivery devices and in particular to a data delivery device in surveillance systems that switches and delivers pictures.

2. Description of Related Art

There are viewpoint-switching surveillance systems in which multiple cameras, sensors, and the like installed on the street are connected together through a communication network to monitor security or watch children. To efficiently monitor security or watch children with such a system, a technology for selecting important information from pictures from cameras or information from sensors and switching display.

As a system for switching picture display, there are multi-viewpoint picture systems for sports broadcasting or the like. In these multi-viewpoint picture systems, viewpoints are selected to the taste or preference of an individual. For example, Japanese Patent Application Laid-Open Publication No. 2003-179908 discloses a delivery device that controls pictures to be delivered based on information on the taste of a viewer.

In monitoring security or watching children, delivery may be controlled sometimes by assigning an importance level to each picture according to the situation of an object to be monitored. For example, Japanese Patent Application Laid-Open Publication No. 2004-80560 discloses a system in which a priority is assigned to each picture input from multiple picture shooting devices or image pickup devices and input pictures to be selected are sequentially switched based on these priorities.

### BRIEF SUMMARY OF THE INVENTION

When pictures are selected to the taste or preference of an individual with the device disclosed in Japanese Patent Application Laid-Open Publication No. 2003-179908, an importance level is not objectively assigned to each picture and thus these pictures are equal in quality. For monitoring security or watching children, a criterion for picture selection is clarified to some degree. Therefore, to reduce the amount of transmitted and received information, a picture in which movement is not observed at all or the like may fluctuate the quality of a picture transmitted from the camera side sometimes. In the device disclosed in Japanese Patent Application Laid-Open Publication No. 2004-80560, picture inputs to be selected are sequentially switched based on the priorities of multiple picture inputs to increase the frequency with which a picture input high in importance level is selected. However, the device cannot instantaneously display information of a high importance level among picture inputs so that a viewer will not miss it.

It is an object of the invention to provide a data delivery device that switches and delivers pictures so that pictures different in quality can be reliably grasped without missing information of a high importance level.

To solve the above problem, the invention provides a data delivery device that receives picture data picked up by multiple image pickup devices through a network and selects an image frame from the received multiple pieces of picture data and delivers it. The data delivery device includes: interfaces that are connected to the network and transmit and receive picture data; a processing unit that processes picture data; and a storage unit that stores picture data. This processing unit selects picture data from multiple image pickup devices that picked up picture data, received through the interface, based on a cumulative value of the number of times of switching the multiple image pickup devices and delivers the picture data. This processing unit preferably delivers picture data from an image pickup device when the cumulative value of the number of times of switching thereof exceeds a preset threshold value(hereinafter, threshold).

To solve the above problem, further, the invention provides a data delivery device that receives picture data picked up by multiple image pickup devices through a network and selects an image frame from the received multiple pieces of picture data and delivers it. The data delivery device includes: interfaces that are connected to the network and transmit and receive picture data; a processing unit that processes picture data; and a storage unit that stores picture data. This processing unit selects picture data from multiple image pickup devices based on the number of image frames from each image pickup device in a predetermined number of consecutive image frames of picture data received through the interface and delivers the picture data. The processing unit preferably compares the numbers of image frames from the individual image pickup devices with one another and selects picture data from an image pickup device largest in the number of image frames and delivers the picture data.

To solve the above problem, furthermore, the invention provides a data delivery device that receives picture data picked up by an image pickup device through a network and delivers the received picture data. The data delivery device includes: an interface that is connected to the network and transmits and receives an image frame containing importance level information as picture data; a storage unit that stores picture data received through the interface; and a processing unit that carries out delivery processing on the image frame based on the importance level information. This processing unit controls a display time for an image frame based on the importance level information of the image frame. When there are multiple image pickup devices, the processing unit controls the image frame to be displayed based on the cumulative value of the importance level information from each of the image pickup devices in a predetermined number of the consecutive image frames from the image pickup devices. This control is carried out based on the cumulative value of importance level information from each image pickup device in a predetermined number of consecutive image frames. The processing unit preferably determines image data to be delivered this time by comparing the following information: the importance level information of the image frame delivered last and the importance level information of the image frame selected this time based on the cumulative value of importance level information.

That is, in this invention, the following processing is carried out to instantaneously display important information: whether or not to display a picture is evaluated when each image frame is received, not at specific time intervals, by accumulating the frequency of viewpoint switching or the number of image frames from each viewpoint. In addition, the display time for each image frame is varied according to importance level information and the viewability of an important frame is thereby enhanced.

The configuration of this invention makes it possible to provide a data delivery device in which important information is not missed and can be instantaneously viewed.

Thus pictures different in quality can be efficiently grasped and information of a high importance level, even though the information is shown in only one frame of picture, is not missed and can be grasped.

### BRIEF DESCRIPTION OF THE DRAWINGS

FIG. 1 illustrates the basic configuration of a system to which the invention is applied;

FIG. 2A illustrates an example of the format of picture data flowing between a camera and a data delivery device in each embodiment;

FIG. 2B illustrates another example of the format of picture data flowing between a camera and a data delivery device in each embodiment;

FIG. 3 illustrates the format of picture data flowing between a data delivery device in each embodiment and a data display device;

FIG. 4 illustrates the basic configuration of a data delivery device in each embodiment;

FIG. 5 illustrates a picture management DB in each embodiment;

FIG. 6 illustrates an example of control based on the number of times of camera switching in a first embodiment;

FIG. 7 illustrates a processing flow in control based on the number of times of camera switching in the first embodiment;

FIG. 8 illustrates an example where control based on the number of times of camera switching cannot be carried out;

FIG. 9 illustrates an example of control based on the number of frames from each camera included in multiple received frames in a second embodiment;

FIG. 10 illustrates a processing flow in control based on the number of frames from each camera included in multiple received frames in the second embodiment;

FIG. 11 illustrates a first example where control based on the number of frames from each camera included in multiple received frames cannot be carried out;

FIG. 12 illustrates an example where control is carried out by combining the following controls in a third embodiment: control based on the number of times of camera switching and control based on the number of frames from each camera included in multiple received frames;

FIG. 13 illustrates a processing flow in control carried out by combining the following controls in the third embodiment: control based on the number of times of camera switching and control based on the number of frames from each camera included in multiple received frames;

FIG. 14 illustrates a second example where control based on the number of frames from each camera included in multiple received frames cannot be carried out;

FIG. 15 illustrates an example of control based on the importance level of a frame from each camera included in multiple received frames in a fourth embodiment;

FIG. 16 illustrates a processing flow in control based on the importance level of a frame from each camera included in multiple received frames in the fourth embodiment;

FIG. 17 illustrates an example of control carried out by combining the following controls in a fifth embodiment: control based on the number of times of camera switching and control based on the importance level of a frame from each camera included in multiple received frames;

FIG. 18 illustrates a processing flow in control carried out by combining the following controls in the fifth embodiment: control based on the number of times of camera switching and control based on the importance level of a frame from each camera included in multiple received frames;

FIG. 19 illustrates an example where a frame of a high importance level is kept displayed in a sixth embodiment;

FIG. 20 illustrates a processing flow in control in which a frame of a high importance level is kept displayed in the sixth embodiment;

FIG. 21 illustrates an example of control carried out by combining the following controls in a seventh embodiment: control based on the number of times of camera switching, control based on the importance level of a frame from each camera included in multiple received frames, and control in which a frame of a high importance level is kept displayed; and

FIG. 22 illustrates a processing flow in control carried out by combining the following controls in the seventh embodiment: control based on the number of times of camera switching, control based on the importance level of a frame from each camera included in multiple received frames, and control in which a frame of a high importance level is kept displayed.

### DETAILED DESCRIPTION OF THE INVENTION

Hereafter, description will be given to embodiments of the invention with reference to the drawings. In the following description, importance level information, or information indicating the importance level of an image frame, may be simply referred to as “importance level” sometimes.

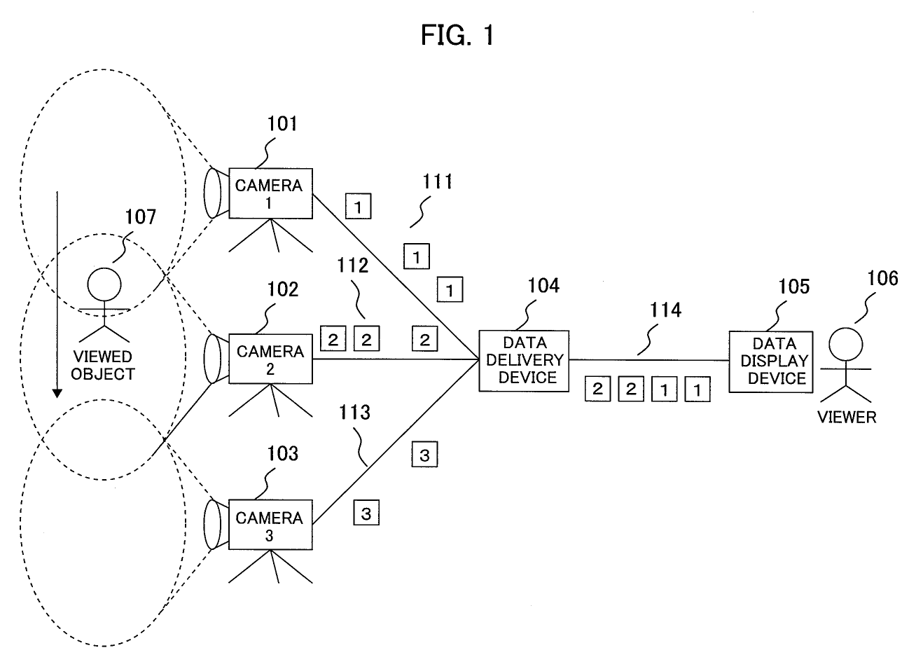

FIG. 1 illustrates the overall configuration of a viewpoint-switching surveillance system as an example of the embodiments of the invention.

In the example in the drawing, a first camera 101, a second camera 102, and a third camera 103 as image pickup devices respectively deliver picked-up pictures to a data delivery device 104 through a line 111, a line 112, and a line 113. The data delivery device 104 extracts a relevant picture, for example, a picture embracing a viewed object 107, from the received pictures in accordance with a request from a viewer 106 and delivers the picture to a data display device 105 through a line 114.

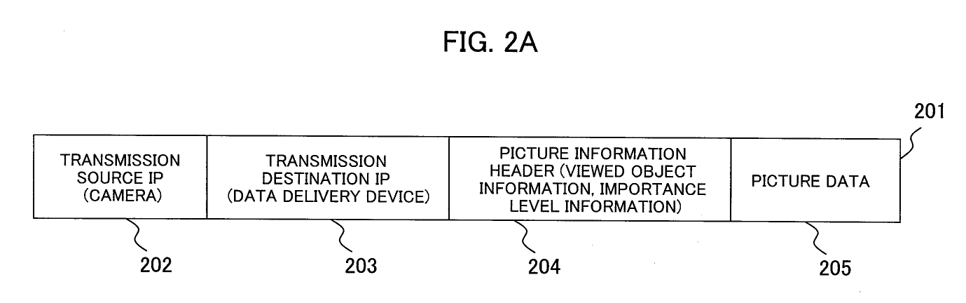

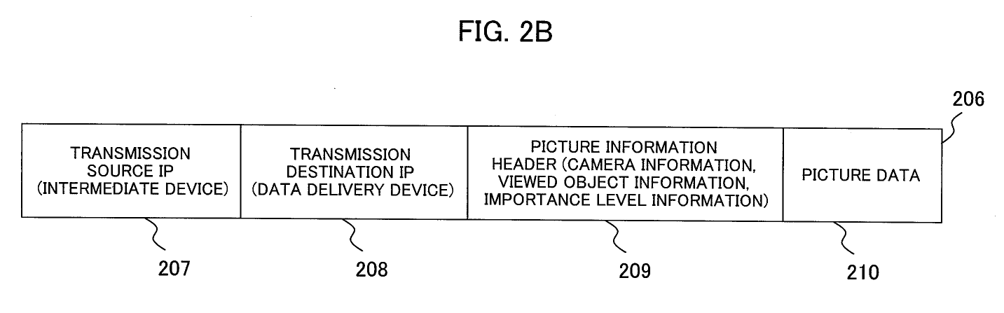

FIGS. 2A and 2B illustrate examples of the format of picture data flowing through the lines 111 to 113 between the cameras 101 to 103 and the data delivery device 104 in the configuration illustrated in FIG. 1. When the cameras 101 to 103 transmit picture data as an IP packet to the data delivery device 104, the cameras 101 to 103 can be identified by transmission source IP 202, or the IP address of a camera as the transmission source of the IP packet as indicated by format 201 in FIG. 2A. A reference numeral 203 denotes transmission destination IP, or the IP address of the data delivery device as the destination of transmission. A picture information header 204 indicating the contents of picture data 205 contains information indicating a viewed object 107 and its importance level (importance level information).

When picture data from the cameras 101 to 103 is transmitted to the data delivery device 104 with an intermediate device intervening, a format 206 illustrated in FIG. 2B is used. When an intermediate device, not shown, exists as indicated in the drawing, the cameras 101 to 103 cannot be identified by the transmission source IP 207 of the IP packet. Therefore, information for identifying the cameras 101 to 103 is included in a picture information header 209 indicating the contents of picture data 210.

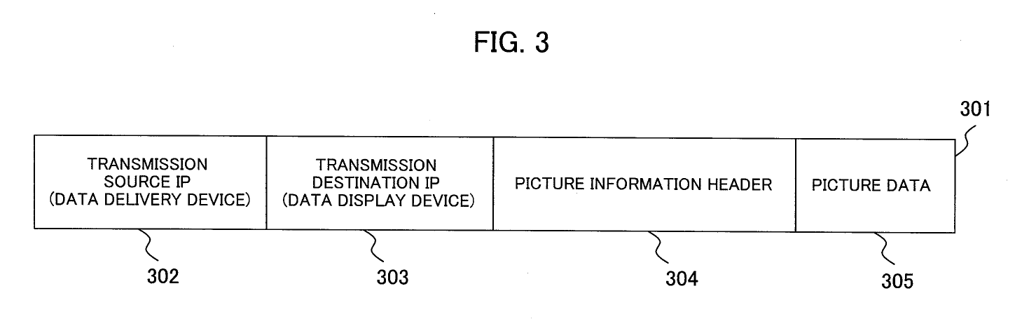

FIG. 3 illustrates an example of the format of picture data flowing through the line 114 between the data delivery device 104 and the data display device 105 in the configuration illustrated in FIG. 1. Similarly with the formats in FIGS. 2A and 2B, a reference numeral 302 denotes transmission source IP indicating the data delivery device; a reference numeral 303 denotes transmission destination IP indicating the data display device; a reference numeral 304 denotes picture information header; and a reference numeral 305 denotes picture data.

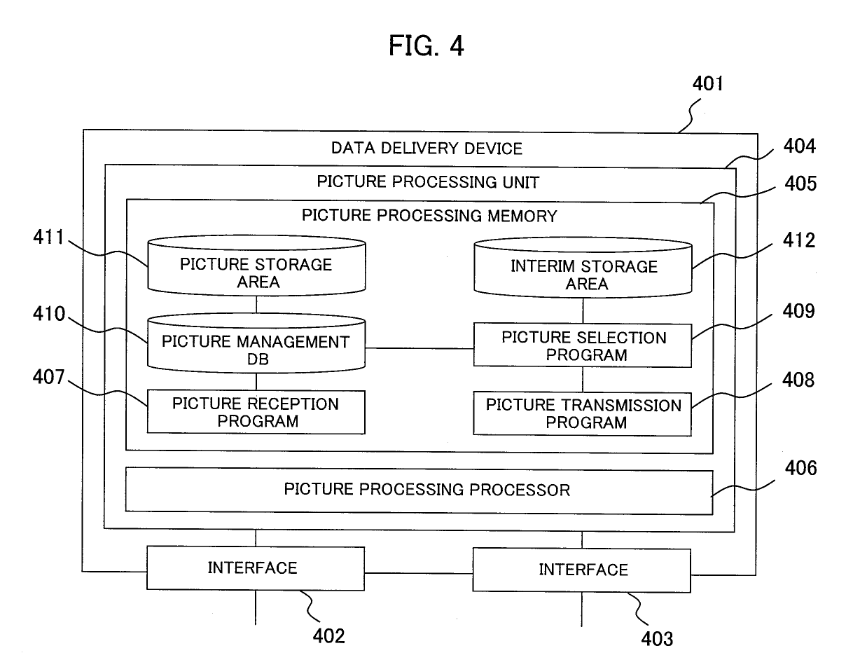

FIG. 4 is a functional block diagram illustrating the basic configuration of the data delivery device 104 in the viewpoint-switching surveillance system illustrated in FIG. 1. In FIG. 4, the data delivery device 401 includes interfaces 402, 403 and a picture processing unit 404 that processes picture data. The picture processing unit 404 includes a picture processing memory 405 and a picture processing processor 406. The picture processing memory 405 has therein a picture reception program 407, a picture transmission program 408, and a picture selection program 409 executed by the picture processing processor 406. The picture processing memory 405 includes a picture management DB 410, a picture storage area 411, and an interim storage area 412 for storing picture data. The picture reception program 407 and the picture transmission program 408 are respectively programs for receiving and transmitting picture data through the interfaces 402, 403. The picture selection program 409 is a program for selecting picture data to be delivered and displayed on the data display device of the viewer from among picture data received from the image pickup devices.

When the picture processing unit 404 of the data delivery device 401 receives a picture data delivery request from the viewer through the interfaces 402, 403, it carries out the following processing by the picture reception program 407: the picture processing unit stores information on the received picture in the picture management DB 410 and stores the received picture data in the picture storage area 411. Further, when the data delivery device 401 receives a picture data delivery request from the viewer through the interfaces 402, 403, it carries out the following processing: the data delivery device extracts a picture corresponding to the picture data delivery request from the picture management DB 410 by the picture selection program 409 and delivers it by the picture transmission program 408. The interim storage area 412 holds temporary information required for processing in accordance with the picture selection program 409. Examples of such information include the cumulative values of varied data described later, the number of times of switching, and the like. The above-mentioned functional configuration can be obtained by an ordinary computer system, such as a server, including a central processing unit (CPU), a storage unit (memory), and a network interface, needless to add.

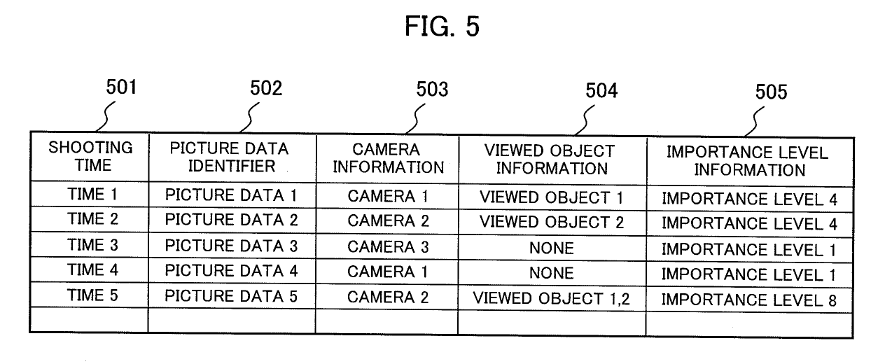

FIG. 5 illustrates an example of the picture management DB 410 in FIG. 4. The picture management DB 410 is comprised of: shooting time 501 at which picture data was picked up; an identifier 502 of the picture data; camera information 503 on a camera that picked up the picture data; viewed object information 504 on a viewed object contained in the picture data; and importance level information 505 on the importance level of the picture data. When the shooting time 501 is contained in the picture information headers 204, 209 in FIG. 2A or 2B, it is generated from the contents of the picture information header. When it is not contained in the picture information header, it is generated from time when the data delivery device 104, 401 received the picture data.

### First Embodiment

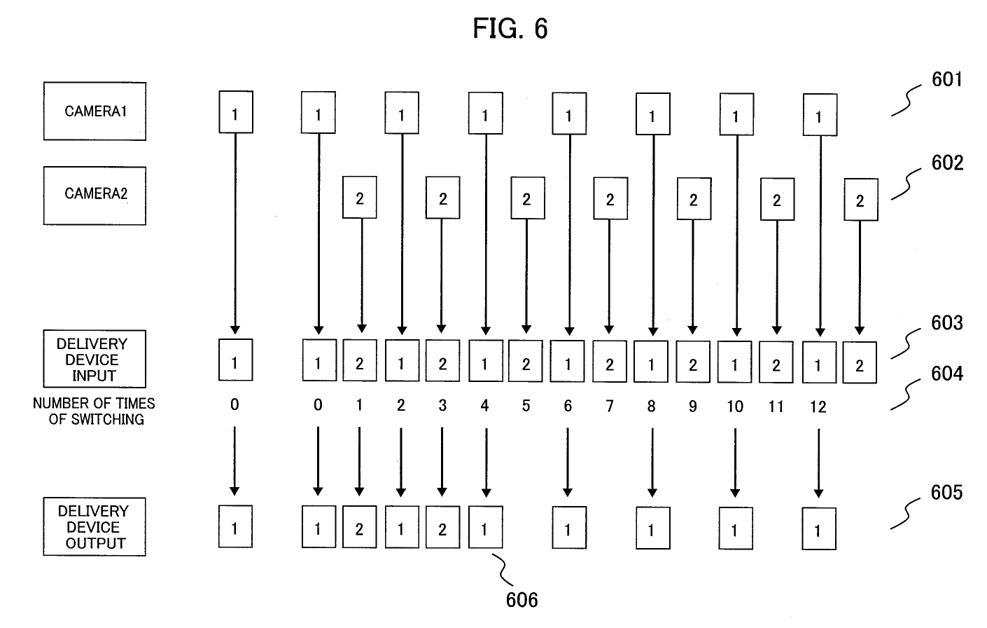

FIG. 6 schematically illustrates an example of control based on the cumulative value of the number of times of camera switching, one of picture selection methods in a first embodiment. The input of the delivery device that receives a picture 601 from camera 1 and a picture 602 from camera 2 equal in frame rate is denoted by a reference numeral 603. Since camera 1 and camera 2 are equal to each other in frame rate, pictures from these cameras are alternately repeated. If these pictures are directly outputted, they are very difficult to view. The number of times of camera switching in the input 603 to the delivery device is denoted by a reference numeral 604. “3” will be taken as the threshold of the number of times of switching. At time 606 when this threshold is exceeded, a camera whose picture should be outputted by the delivery device is fixed. The output of the delivery device is denoted by a reference numeral 605. As denoted by this reference numeral, the pictures from camera 1 and from camera 2 are prevented from being alternately displayed and this makes the displayed picture easy to view.

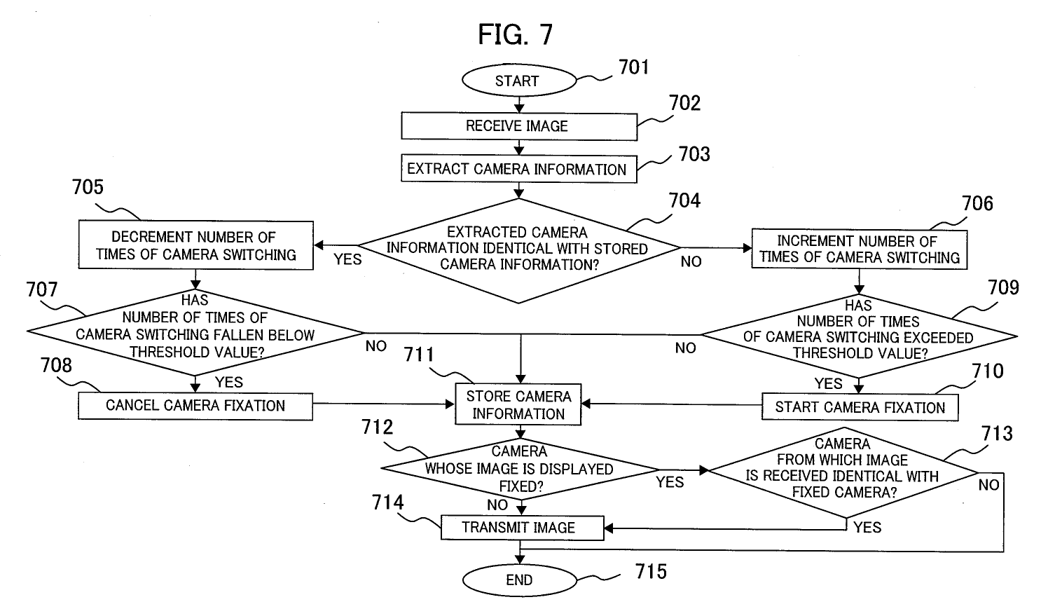

FIG. 7 illustrates a processing flow in the first embodiment illustrated in FIG. 6. In the drawing, reference numerals 701 to 715 denote the individual steps of the processing flow. This is the same with the following processing flowcharts. When the data delivery device 104 receives an image (702), it extracts camera information (703) and determines whether or not the extracted camera information is identical with stored camera information (704). When they are identical with each other, the number of times of camera switching is decremented (705). When they are not identical with each other, the number of times of camera switching is incremented (706).

When the number of times of camera switching is decremented at Step 705, it is determined whether or not the number of times of camera switching has fallen below a threshold (707). When it has fallen below the threshold, the fixation of the camera is canceled (708). When the number of times of camera switching is incremented at Step 706, it is determined whether or not the number of times of camera switching has exceeded a threshold (709). When it has exceeded the threshold, the fixation of the camera is started (710). Subsequently, the camera information of the received image is stored (711) and it is determined whether or not a camera whose image is displayed is fixed (712). When the camera is not fixed and when the camera is fixed but it is matched with the camera information of the received image, the received image is displayed (714). When the camera is fixed and it is not matched with the camera information of the received image, the received image is not displayed and this series of processing is terminated (715).

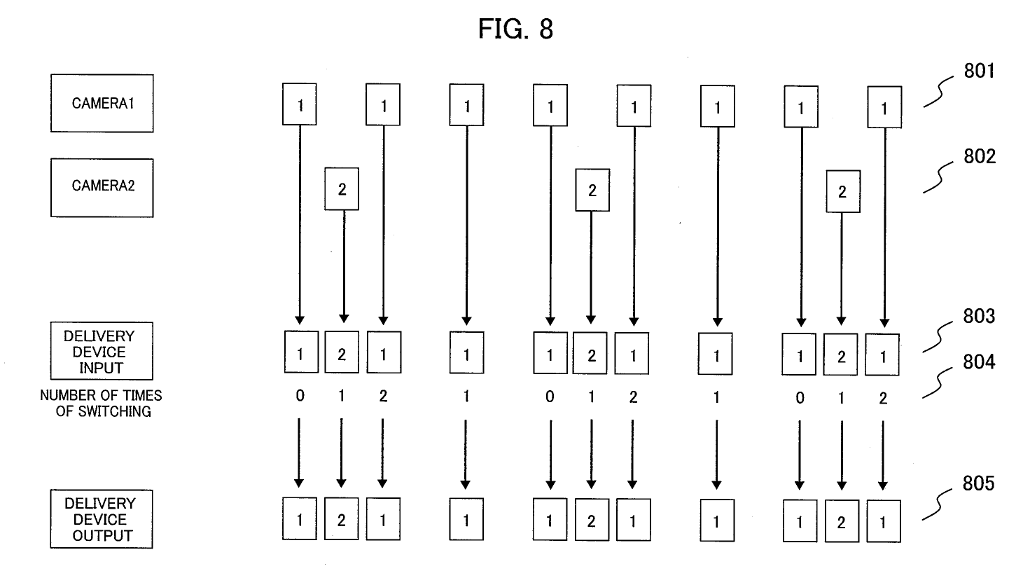

FIG. 8 illustrates an example where delivered pictures cannot be controlled based on the number of times of camera switching as in the first embodiment illustrated in FIG. 6 and FIG. 7. The input to the delivery device 104 that receives a picture 801 from camera 1 and a picture 802 from camera 2, different in frame rate, is denoted by a reference numeral 803. At this time, the number of times of camera switching is as denoted by a reference numeral 804. Since a certain number of times of camera switching is maintained and the threshold of 3 is not exceeded, the following takes place under the same control as illustrated in FIG. 6 and FIG. 7: the output of the delivery device 104 is as denoted by a reference numeral 805 and a picture from camera 1 and a picture from camera 2 is continuously mixed into a picture from camera 1.

### Second Embodiment

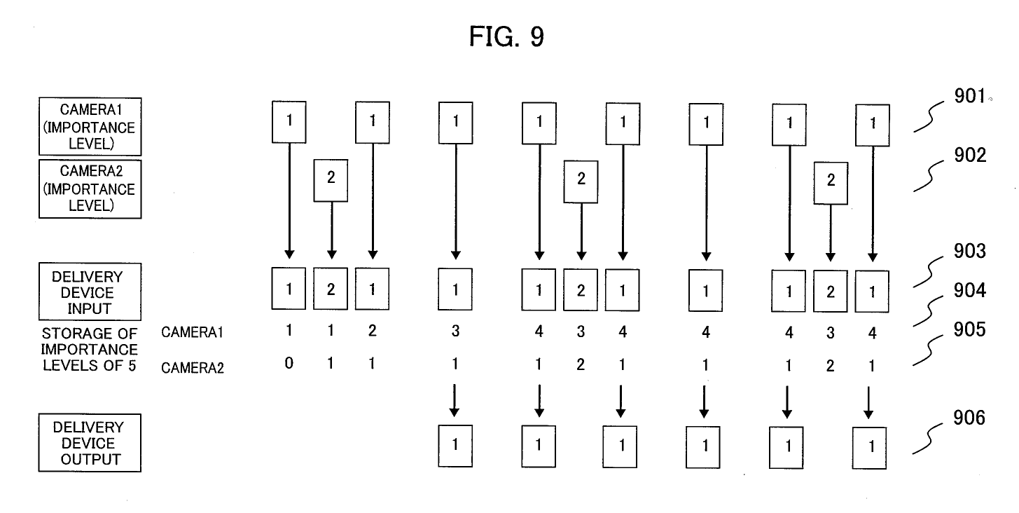

FIG. 9 illustrates a picture selection method in a second embodiment. To control the case illustrated in FIG. 8, in this embodiment, control is carried out based on the number of frames from each camera included in multiple received frames, that is, a predetermined number of multiple consecutive received image frames. As in the case illustrated in FIG. 8, the input of the delivery device 104 that receives a picture 901 from camera 1 and a picture 902 from camera 2 is as denoted by a reference numeral 903. At this time, the number of frames from camera 1 included in newly received five frames is as denoted by a reference numeral 904 and the number of frames from camera 2 included in the same frames is as denoted by a reference numeral 905. When the number of frames from a camera is larger than that from the other camera and the number of frames from the camera is equal to or larger than the threshold of 3, a frame is outputted. In this case, the output of the delivery device 104 is as denoted by a reference numeral 906 and unlike the case illustrated in FIG. 8 pictures are prevented from being mixed.

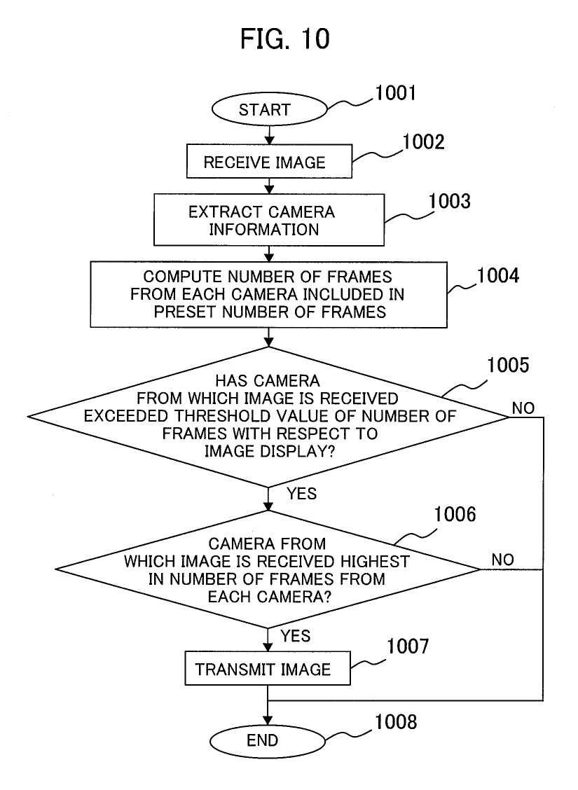

FIG. 10 illustrates a processing flow in the picture selection method in the second embodiment illustrated in FIG. 9. When the data delivery device 104 receives a picture (1002), it extracts camera information (1003) and computes the number of frames from each camera included in the preset number of frames (1004). Subsequently, it is determined whether or not the camera from which the image is received has exceeded a threshold of the number of frames with respect to image display (1005). When the camera has exceeded the threshold, it is determined whether or not the camera from which the image is received is largest in the number of frames from each camera among all the cameras (1006). When the camera is largest in the number of frames from each camera, the image received from the camera is displayed (1007).

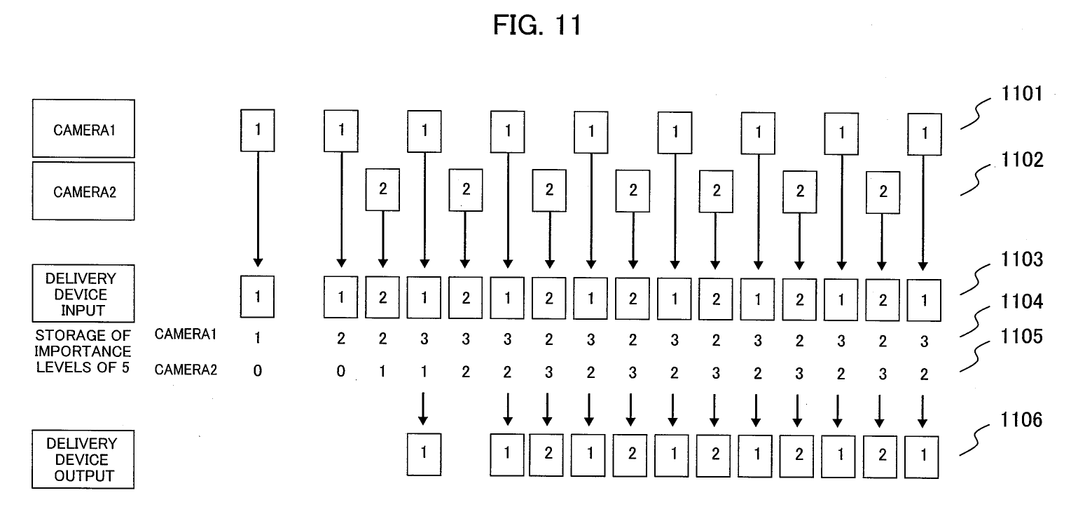

FIG. 11 illustrates an example where delivered pictures cannot be controlled based on the number of frames from each camera included in multiple received frames unlike the case illustrated in FIG. 9 and FIG. 10. Similarly with the example illustrated in FIG. 6, the input of the delivery device that receives a picture (1101) from camera 1 and a picture (1102) from camera 2, equal in frame rate, is as denoted by a reference numeral 1103 and pictures from camera 1 and from camera 2 are alternately repeated. At this time, the number of frames from camera 1 included in five received frames is as denoted by a reference numeral 1104 and the number of frames from camera 2 included in the same frames is as denoted by a reference numeral 1105. Thus the same values are alternately repeated. Under the same control as illustrated in FIG. 9, therefore, the output of the delivery device is as denoted by a reference numeral 1106 and a picture from camera 1 and a picture from camera 2 are alternately repeated.

### Third Embodiment

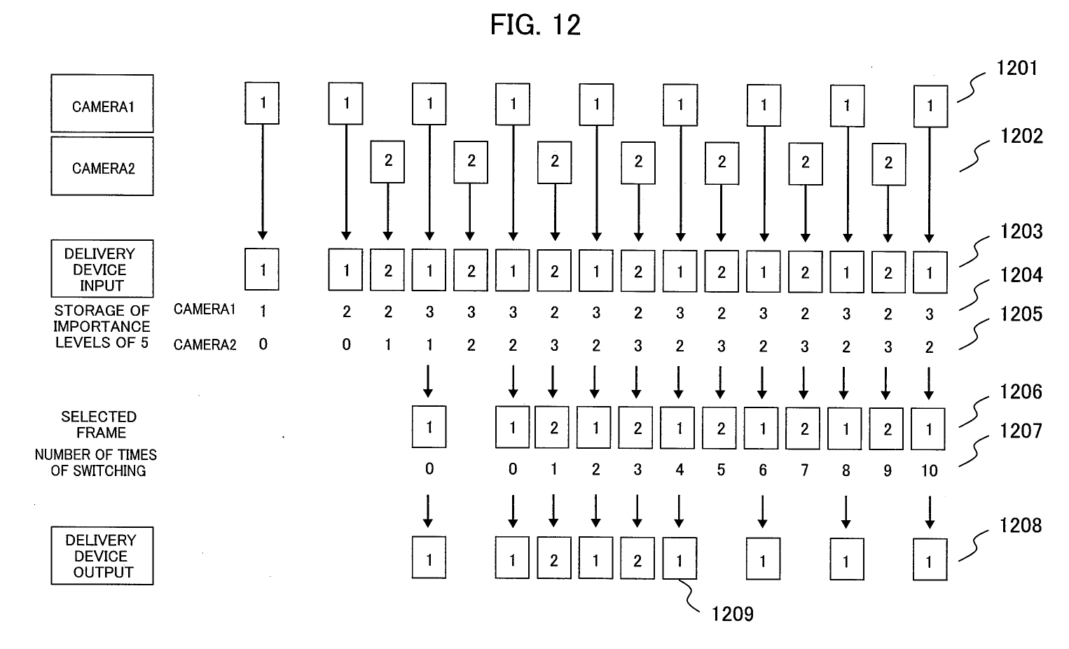

FIG. 12 illustrates a picture selection method in a third embodiment. To make it possible to control the case illustrated in FIG. 11, in this embodiment, control is carried out by combining the following controls: control based on the number of times of camera switching (cumulative value) in the first embodiment; and control based on the number of frames from each camera included in multiple received frames in the second embodiment. Similarly with the example illustrated in FIG. 11, the input of the delivery device 104 that receives a picture 1201 from camera 1 and a picture 1202 from camera 2 is as denoted by a reference numeral 1203; and the number of frames from camera 1 included in the five received frames is as denoted by a reference numeral 1204 and the number of frames from camera 2 included in the same frames is as denoted by a reference numeral 1205. The frame selected by control based on the five received frames is as denoted by a reference numeral 1206 and at this time the number of times of camera switching is as denoted by a reference numeral 1207. “3” will be taken as the threshold of the number of times of switching 1207. At time 1209 when this threshold is exceeded, a camera whose picture should be outputted is fixed. As a result, the output of the delivery device is as denoted by a reference numeral 1208.

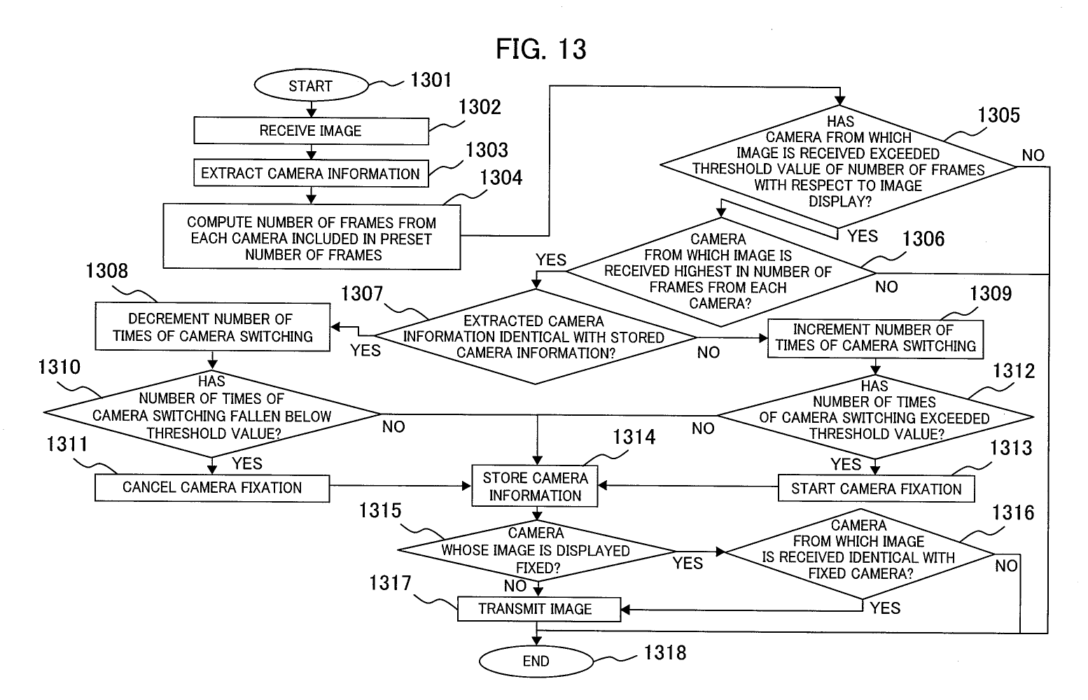

FIG. 13 illustrates a processing flow in the third embodiment illustrated in FIG. 12. When the data delivery device 104 receives a picture (1302), it extracts camera information (1303) and computes the number of frames from each camera included in a preset number of frames (5 in this example) (1304). Subsequently, it is determined whether or not the camera from which the image is received has exceeded a threshold of the number of frames with respect to image display (1305). When the camera has exceeded the threshold, it is determined whether or not the camera from which the image is received is largest in the number of frames from each camera among all the cameras (1306). When the camera is largest in the number of frames from each camera, it is determined whether or not the extracted camera information is identical with stored camera information (1307). When they are identical with each other, the number of times of camera switching 1207 is decremented (1308). When they are not identical with each other, the number of times of camera switching is incremented (1309). When the number of times of camera switching is decremented at Step 1308, it is determined whether or not the number of times of camera switching has fallen below a threshold (1310). When it has fallen below the threshold, the fixation of the camera is canceled (1311). When the number of times of camera switching is incremented at Step 1309, it is determined whether or not the number of times of camera switching has exceeded a threshold (1312). When it has exceeded the threshold, the fixation of the camera is started (1313). Subsequently, the camera information of the received image is stored (1314) and it is determined whether or not a camera whose image is displayed is fixed (1315). When the camera is not fixed and when the camera is fixed but it is matched with the camera information of the received image, the received image is displayed (1317). When the camera is fixed and it is not matched with the camera information of the received image, the received image is not displayed and this series of processing is terminated (1318). The camera information of the received image stored at Step 1314 is the information of the image in the selected frame 1206 in FIG. 12.

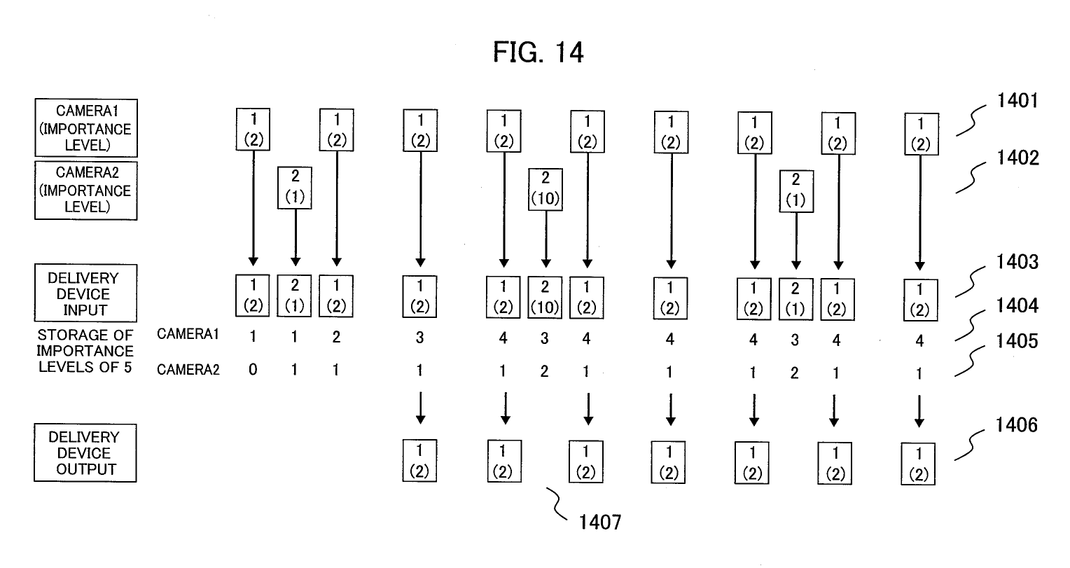

FIG. 14 illustrates a second example where delivered pictures cannot be desirably controlled based on the number of frames from each camera included in multiple received frame unlike the case illustrated in FIG. 9 and FIG. 10. Similarly with the example illustrated in FIG. 9, the input of the delivery device that receives a picture 1401 from camera 1 and a picture 1402 from camera 2, different in frame rate, is as denoted by a reference numeral 1403; the number of frames from camera 1 included in the five received frames is as denoted by a reference numeral 1404 and the number of frames from camera 2 included in the same frames is as denoted by a reference numeral 1405. The pictures 1401, 1402 from camera 1 and camera 2 contain information on importance level (importance level information) indicated by parenthesized numerals. At this time, the output of the delivery device 104 is as denoted by a reference numeral 1406 and a frame 1407 of a high importance level (frame of importance level (10) from camera 2) is not displayed.

### Fourth Embodiment

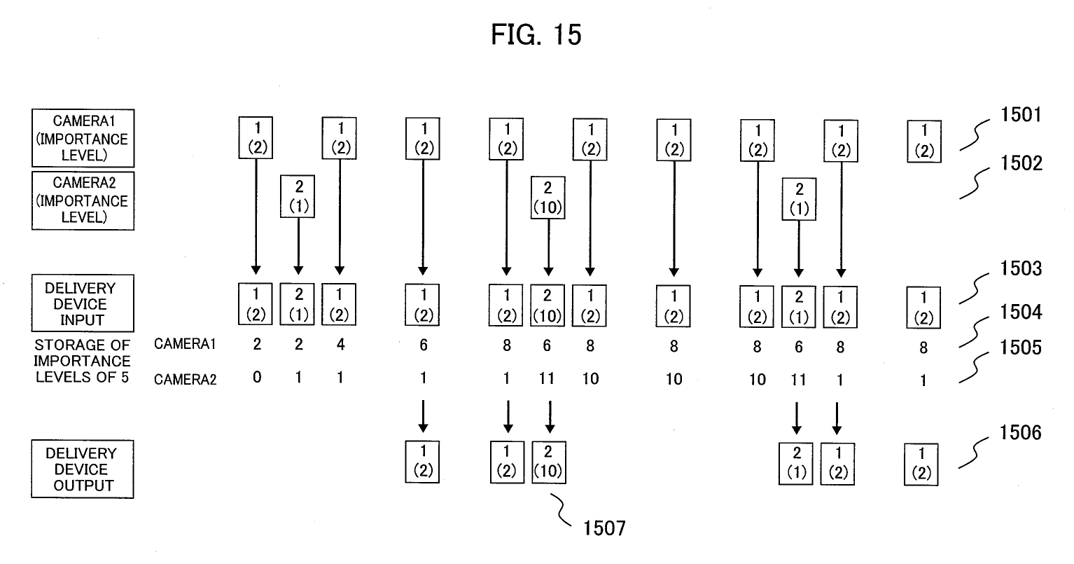

FIG. 15 illustrates a fourth embodiment. To make it possible to control the case illustrated in FIG. 14, in this embodiment, control is carried out based on importance level information contained in each frame received from each camera. Similarly with the example illustrated in FIG. 14, the input of the delivery device 104 that receives a picture 1501 from camera 1 and a picture 1502 from camera 2 is as denoted by a reference numeral 1503. At this time, the importance level of a frame from camera 1 included in newly received five frames is as denoted by a reference numeral 1504 and the importance level of a frame from camera 2 included in the same frames is as denoted by a reference numeral 1505. A frame is outputted when both the following conditions are met: the importance level information of a frame from a camera included in the five received frames should be higher than that of a frame from the other camera; and the importance level information of a frame from the camera should be equal to or higher than a threshold of (6). In this case, the output of the delivery device is as denoted by a reference numeral 1506 and a frame 1507 of a high importance level (frame of importance level (10) from camera 2) is displayed.

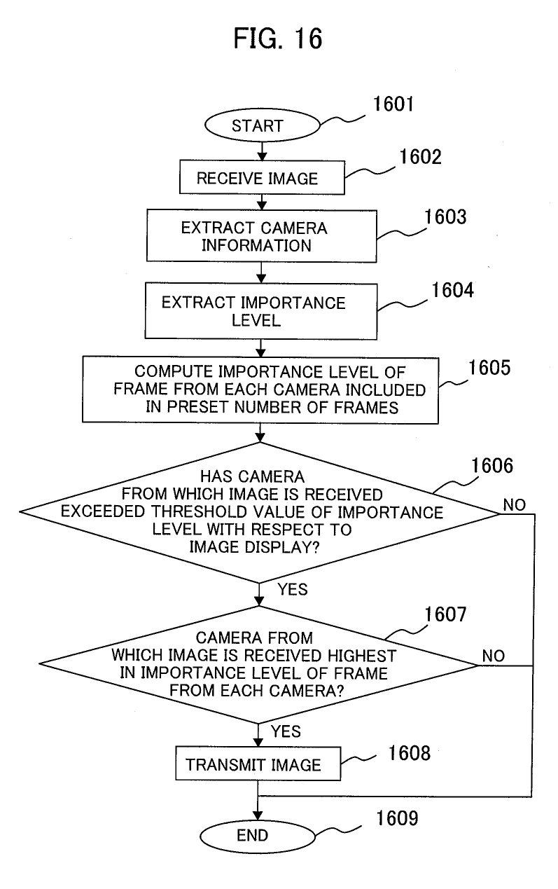

FIG. 16 illustrates a processing flow in the fourth embodiment illustrated in FIG. 15. When the data delivery device 104 receives a picture (1602), it extracts camera information (1603) and extracts importance level (1604). Then it computes the importance level of a frame from each camera included in the preset number of frames (1605). Subsequently, it is determined whether or not the camera from which the image is received has exceeded a threshold of importance level with respect to image display (1606). When the camera has exceeded the threshold, it is determined whether or not the camera from which the image is received is highest in the importance level of a frame from each camera among all the cameras (1607). When the camera is highest in the importance level of a frame from each camera, the received image is displayed (1608).

### Fifth Embodiment

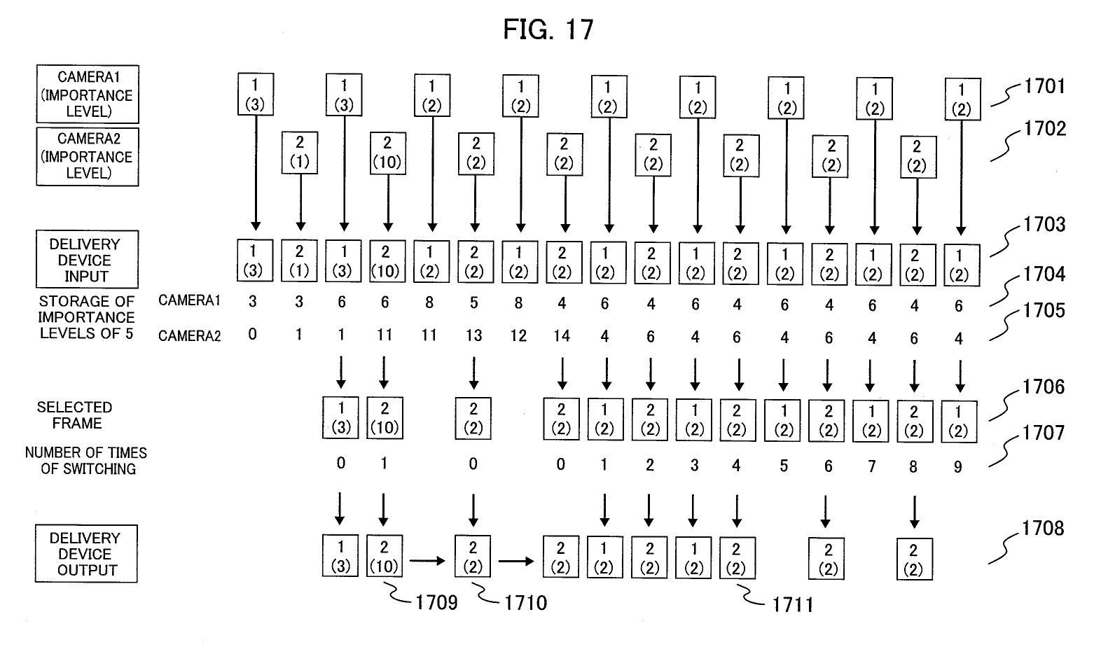

FIG. 17 illustrates a picture selection method in a fifth embodiment. In this embodiment, control is carried out by combining control based on the number of times of camera switching and control based on the importance level information of a frame from each camera included in multiple received frames. The input of the delivery device that receives a picture 1701 from camera 1 and a picture 1702 from camera 2 is as denoted by a reference numeral 1703. At this time, the importance level of a frame from camera 1 included in five received frames is as denoted by a reference numeral 1704; and the importance level of a frame from camera 2 included in the same frames is as denoted by a reference numeral 1705. Similarly with the above embodiment, a frame is outputted when both the following conditions are met: the importance level of a frame from a camera included in five received frames should be higher than that of a frame from the other camera; and the importance level information of a frame from the camera should be equal to or higher than a threshold of (6). In this case, the selected frame is as denoted by a reference numeral 1706 and at this time the number of times of camera switching is as denoted by a reference numeral 1707. “3” will be taken as the threshold of the number of times of switching 1707. At time 1711 when the threshold of (6) is exceeded, a camera whose picture should be outputted is fixed. As denoted by a reference numeral 1708, as a result, a frame 1709 of a high importance level is outputted from the delivery device 104.

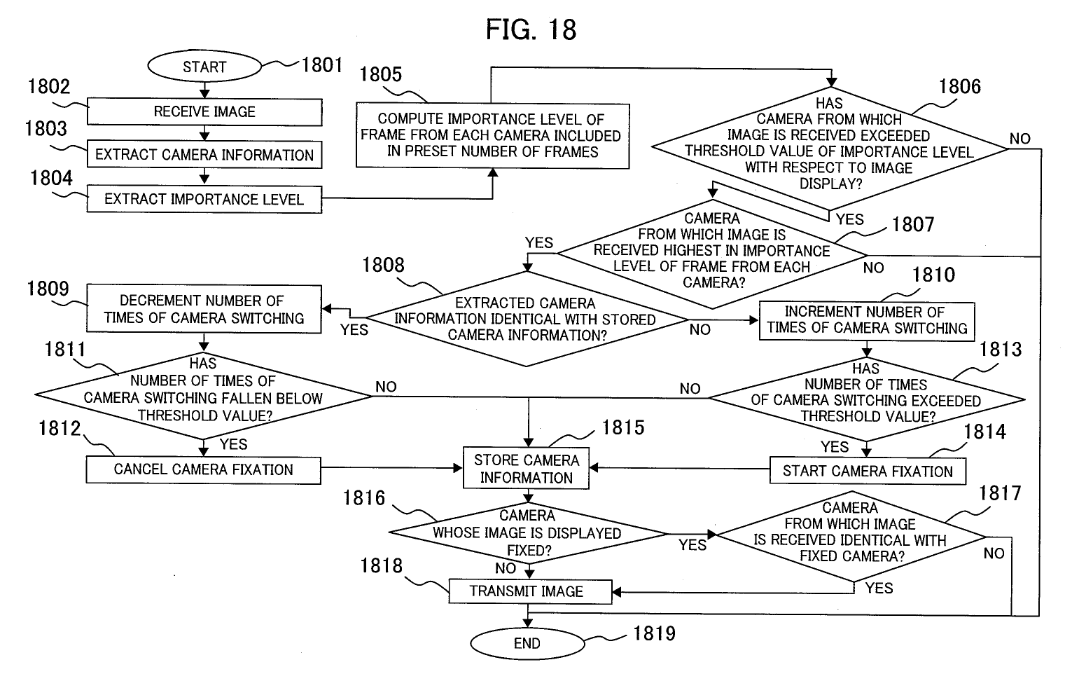

FIG. 18 illustrates a processing flow in the fifth embodiment illustrated in FIG. 17. When the data delivery device 104 receives a picture (1802), it extracts camera information (1803) and extracts importance level (1804). Then it computes the importance level of a frame from each camera included in the preset number of frames (1805). Subsequently, it is determined whether or not the camera from which the image is received has exceeded a threshold of importance level with respect to image display (1806). When the camera has exceeded the threshold, it is determined whether or not the camera from which the image is received is highest in the importance level of a frame from each camera among all the cameras (1807). When the camera is highest in the importance level of a frame from each camera, it is determined whether or not the extracted camera information is identical with stored camera information (1808). When they are identical with each other, the number of times of camera switching is decremented (1809). When they are not identical with each other, the number of times of camera switching is incremented (1810). When the number of times of camera switching is decremented at Step 1809, it is determined whether or not the number of times of camera switching has fallen below a threshold (1811). When it has fallen below the threshold, the fixation of the camera is canceled (1812). When the number of times of camera switching is incremented at Step 1810, it is determined whether or not the number of times of camera switching has exceeded a threshold (1813). When it has exceeded the threshold, the fixation of the camera is started (1814). Subsequently, the camera information of the received image is stored (1815) and it is determined whether or not a camera whose image is displayed is fixed (1816). When the camera is not fixed and when the camera is fixed but it is matched with the camera information of the received image, the received image is displayed (1818). When the camera is fixed and is not matched with the camera information of the received image, the received image is not displayed and this series of processing is terminated (1819). The camera information of the received image stored at Step 1815 is the information of the image in the selected frame 1706 in FIG. 17.

In the fifth embodiment in FIG. 17, the output 1708 of the delivery device 104 containing a frame of a high importance level is obtained. However, the display of a frame 1709 of a high importance level is overwritten with the display of a frame 1710 of a low importance level from the same camera. This shortens the display time for the frame 1709 of a high importance level and it can be missed.

### Sixth Embodiment

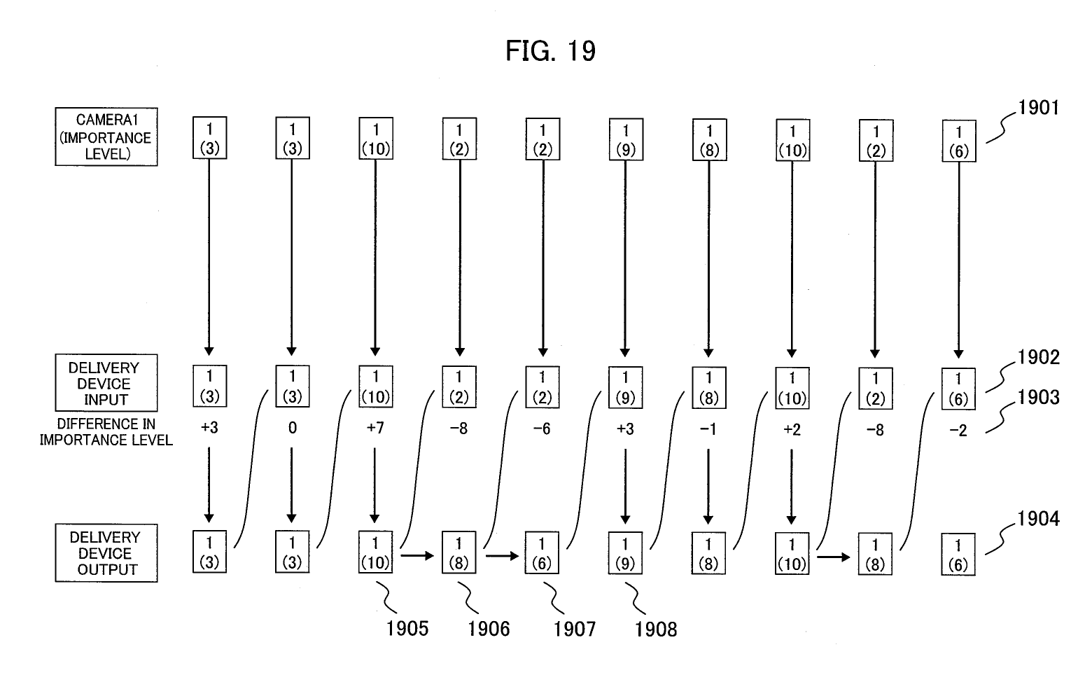

FIG. 19 illustrates a picture selection method in a sixth embodiment. In this embodiment, a frame of a high importance level is kept displayed based on the difference in importance level information between an outputted frame and a received frame. The possibility of the display of the frame of a high importance level being missed is thereby reduced. The input of the delivery device that receives a picture 1901 from camera 1 is as denoted by a reference numeral 1902. At this time, the difference in importance level between the frame outputted last by the delivery device 104 and the received frame is as denoted by a reference numeral 1903. When a frame is outputted with the difference in importance level of the received frame equal to or higher than a threshold of (−5), the output of the delivery device 104 is as denoted by a reference numeral 1904. Thus a frame 1905 of a high importance level is kept displayed until a frame having a predetermined condition of the importance level is received, namely, a frame 1908 of FIG. 19 is received and displayed. In addition, the importance level of the stored image is decremented by a certain value (for example, −2). That is, the delivery period of a frame is controlled based on information on the importance level of the frame. With respect to a frame of a high importance level, it is possible to lengthen the delivery period for which it is delivered and the display time for which it is displayed.

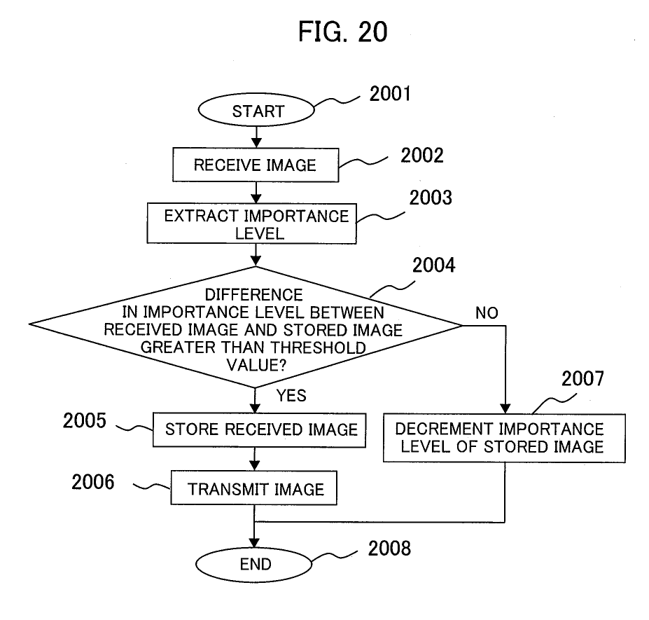

FIG. 20 illustrates a processing flow in the fifth embodiment illustrated in FIG. 19. When the data delivery device 104 receives a picture (2002), it extracts importance level (2003). Then it is determined whether or not the difference in importance level between the received image and a stored image is greater than the threshold of (−5) (2004). When the threshold is exceeded, the received image is stored (2005) and the received image is displayed (2006). When the threshold is not exceeded, the importance level of the stored image is decremented by a certain value (2007).

### Seventh Embodiment

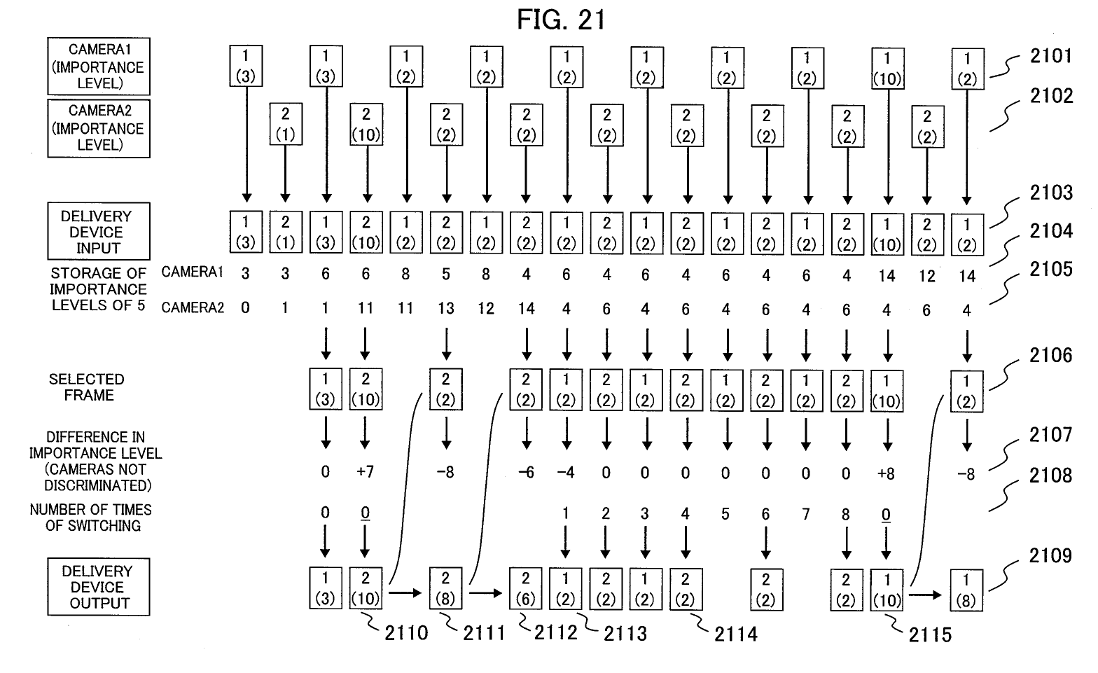

FIG. 21 illustrates a picture selection method in a seventh embodiment. In this embodiment, control is carried out by combining the following controls: control based on the number of times of camera switching; control based on the importance level information of a frame from each camera included in multiple received frames; and control based on the difference in importance level information between an outputted frame and a received frame. The input of the delivery device that receives a picture 2101 from a camera 1 and a picture 2102 from camera 2 is as denoted by a reference numeral 2103. At this time, the importance level of a frame from camera 1 included in five received frames is as denoted by a reference numeral 2104 and the importance level of a frame from camera 2 included in the same frames is as denoted by a reference numeral 2105. A frame is outputted when both the following conditions are met: the importance level of a frame from a camera included in five received frames should be higher than that of a frame from the other camera; and the importance level of a frame from the camera should be equal to or higher than a threshold of (6). In this case, the selected frame is as denoted by a reference numeral 2106; and the difference in importance level between the frame outputted last by the delivery device 104 and the selected frame is as denoted by a reference numeral 2107.

When this difference 2107 in importance level is equal to or larger than a second threshold of (+4), the number of times of camera switching (2108) is initialized to zero and the fixture of the camera is canceled. When the difference in importance level (2107) is equal to or larger than a first threshold of (−4), the following processing is carried out: “3” will be taken as the threshold of the number of times of camera switching (2108); and at time 2114 when this threshold is exceeded, the camera whose picture is outputted is fixed. As denoted by a reference numeral 2109, as the result of the above processing, frames 2110 and 2115 of a high importance level are outputted from the delivery device 104.

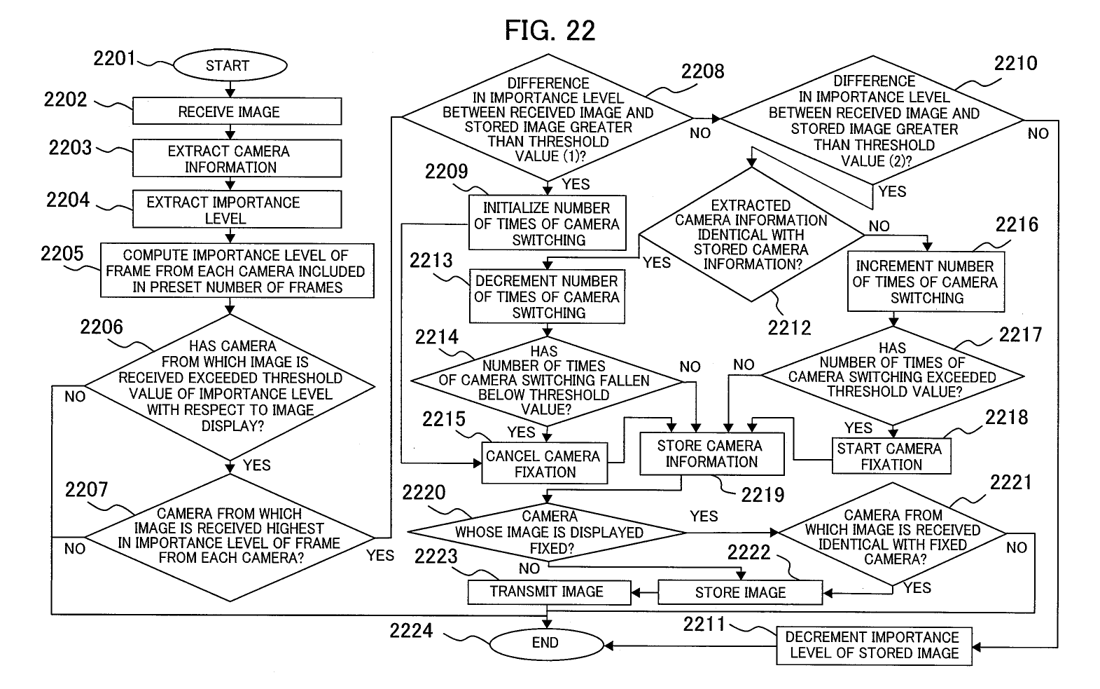

FIG. 22 illustrates a processing flow in the seventh embodiment illustrated in FIG. 21. When the data delivery device 104 receives a picture (2202), it extracts camera information (2203) and extracts importance level (2204). Then it computes the importance level of a frame from each camera included in a preset number of frames (2205). Subsequently, it is determined whether or not the camera from which the image is received has exceeded a threshold of importance level with respect to image display (2206). When the camera has not exceeded the threshold, this series of processing is terminated (2224). When the camera has exceeded the threshold, it is determined whether or not the camera from which the image is received is highest in the importance level of a frame from each camera among all the cameras (2207). When the camera is not highest, this series of processing is terminated (2224).

When the camera is highest in the importance level of a frame from each camera, it is determined whether or not the difference in importance level between the received image and a stored image is greater than the second threshold of (+4) (2208). When the second threshold is exceeded, the number of times of camera switching is initialized (2209) and the fixation of the camera is canceled (2215). When the second threshold is not exceeded, it is determined whether or not the difference in importance level between the received image and the stored image is greater than the first threshold of (−4) (2210). When the first threshold is not exceeded, the importance level of the stored image is decremented by a certain value (−2) (2211) and this series of processing is terminated (2224).

When the second threshold is exceeded, it is determined whether or not the extracted camera information is identical with stored camera information (2212). When they are identical with each other, the number of times of camera switching is decremented (2213). When they are not identical with each other, the number of times of camera switching is incremented (2216). When the number of times of camera switching is decremented at Step 2213, it is determined whether or not the number of times of camera switching has fallen below a threshold (2214). When it has fallen below the threshold, the fixation of the camera is canceled (2215). When the number of times of camera switching is incremented at Step 2216, it is determined whether or not the number of times of camera switching has exceeded a threshold (2217). When it has exceeded the threshold, the fixation of the camera is started (2218). Subsequently, the camera information of the received image is stored (2219) and it is determined whether or not a camera whose image is displayed is fixed (2220). When the camera is not fixed and when the camera is fixed but it is matched with the camera information of the received image, the received image is stored (2222) and displayed (2223). When the camera is fixed and it is not matched with the camera information of the received image, the received image is not displayed and this series of processing is terminated (2224).

The invention described in detail up to this point can be used for picture display control in, for example, monitoring systems and surveillance systems.

1. A data delivery device receiving picture data picked up by a plurality of image pickup devices through a network and selecting and delivering image frames of a plurality of pieces of the picture data received, comprising:
an interface connected to the network and transmitting and receiving the picture data;
a processing unit processing the picture data; and
a storage unit storing the picture data,
wherein the processing unit selects the picture data from the image pickup devices based on the cumulative value of the number of times of switching the image pickup devices that picked up the picture data, received through the interface and delivers the picture data.

2. The data delivery device of claim 1,
wherein the processing unit delivers the picture data from the image pickup device when the cumulative value of the number of times of switching exceeds a preset threshold.

3. A data delivery device receiving picture data picked up by a plurality of image pickup devices through a network and selecting and delivering image frames of a plurality of pieces of the picture data received, comprising:
an interface connected to the network and transmitting and receiving the picture data;
a processing unit processing the picture data; and
a storage unit storing the picture data,
wherein the processing unit selects the picture data from the image pickup devices based on the number of the image frames from each of the image pickup devices in a predetermined number of the consecutive image frames of the picture data received through the interface and delivers the picture data.

4. The data delivery device of claim 3,
wherein the processing unit compares the number of the image frames from each of the image pickup devices in the predetermined number of the consecutive image frames and selects the picture data from the image pickup device largest in the number of the image frames and delivers the picture data.

5. The data delivery device of claim 3,
wherein the processing unit selects the picture data from the image pickup devices based on the number of the image frames from each of the image pickup devices in the predetermined number of the consecutive image frames and delivers the picture data from the image pickup device selected when the number of times of switching from the image pickup device exceeds a preset threshold.

6. The data delivery device of claim 5,
wherein the processing unit compares the number of the image frames from each of the image pickup devices in the predetermined number of the consecutive image frames and selects the picture data from the image pickup device largest in the number of the image frames.

7. A data delivery device receiving picture data picked up by a image pickup device through a network and delivers the received picture data, comprising:
an interface connected to the network and receiving an image frame containing importance level information as the picture data;
a storage unit storing the picture data received through the interface; and
a processing unit carrying out delivery processing on the image frame based on the importance level information,
wherein the processing unit controls the display time for the image frame based on the importance level information of the image frame.

8. The data delivery device of claim 7,
wherein there are a plurality of the image pickup devices, and
wherein the processing unit controls the image frame to be displayed based on the cumulative value of the importance level information from each of the image pickup devices in a predetermined number of the consecutive image frames from the image pickup devices.

9. The data delivery device of claim 8,
wherein the processing unit delivers the image data from the image pickup device selected when the number of times of switching the image pickup devices switched based on the cumulative value of the importance level information exceeds a predetermined threshold.

10. The data delivery device of claim 8,
wherein the processing unit selects the image data to be delivered this time by comparing the importance level information of the image frame delivered last with the importance level information of the image frame selected this time based on the cumulative value of the importance level information.

11. The data delivery device of claim 10,
wherein the processing unit delivers the image data from the image pickup device selected when the number of times of switching the image pickup devices, switched based on the cumulative value of the importance level information after the comparative difference in the importance level information exceeds a predetermined first threshold, exceeds a predetermined value.

12. The data delivery device of claim 11,
wherein the processing unit delivers the image data from the image pickup device when the comparative difference in the importance level information exceeds a predetermined second threshold.
